(19) United States
(12) Patent Application Publication
(10) Pub. No.: US 2026/0302676 A1
(43) Pub. Date: Oct. 1, 2026

(54) CONNECTOR AND CONNECTOR ASSEMBLY

(71) Applicant: SUMITOMO WIRING SYSTEMS, LTD., Mie (JP)

(72) Inventor: Yuya SHINKAWA, Mie (JP)

(21) Appl. No.: 19/568,018

(22) Filed: Mar. 16, 2026

(30) Foreign Application Priority Data
Mar. 25, 2025 (JP) 2025-049864

(51) Int. Cl. H01R 13/436; H01R 12/70; H01R 13/504; H01R 13/516

(52) U.S. Cl. CPC H01R 13/4361; H01R 12/7005; H01R 13/5045; H01R 13/516

(57) ABSTRACT

A connector includes a housing, a retainer, and a hood member having an opening. The housing and the retainer are assembled into the hood member from the opening in a first direction. The retainer is assembled to the housing in a second direction intersecting the first direction. The retainer is movable in the second direction relative to the housing from a provisional locking position to a final locking position, within the hood member. The hood member includes a first side wall that is located on a side opposite to the second direction and covers the housing and the retainer. A part of the first side wall covering the retainer is provided with a through hole penetrating the first side wall.

### CROSS-REFERENCE TO RELATED APPLICATIONS

This application is based on and claims priority from Japanese Patent Application No. 2025-049864, filed on Mar. 25, 2025, with the Japan Patent Office, the disclosure of which is incorporated herein in its entirety by reference.

### TECHNICAL FIELD

The present disclosure relates to a connector and a connector assembly.

### BACKGROUND

JPH11-233186 A discloses a technique in which a side retainer is applied to a hooded connector. The side retainer in the connector described in JP H11-233186 A is inserted into a housing disposed in a hood from a direction intersecting the insertion direction of a terminal fitting. The side retainer is supported in the housing so as to be movable in the direction intersecting the insertion direction of the terminal fitting between a provisional locking position that allows insertion of the terminal fitting and a final locking position at which the side retainer is lockable to the terminal fitting.

### SUMMARY

In the case of moving the side retainer in JP H11-233186 A from the provisional locking position to the final locking position, an operator inserts a rod-shaped jig between the hood and the housing through an opening of the hood. The operator then presses the tip of the jig into an operation groove provided on the outer surface of the side retainer and pushes the side retainer downward. This operation requires the skill to finely manipulate the jig.

The present disclosure has an objective of providing a connector in which a retainer can be easily final-locked to a housing within a hood member.

A connector according to the present disclosure comprises: a housing that accommodates terminals; a retainer that is assembled to the housing to hold the terminals in the housing; and a hood member that has an opening and accommodates the housing and the retainer, wherein the housing and the retainer are assembled into the hood member from the opening in a first direction, the retainer is assembled to the housing in a second direction intersecting the first direction, the retainer is movable in the second direction relative to the housing from a provisional locking position that allows movement of the terminals to a final locking position that restricts the movement of the terminals, within the hood member, the hood member includes a first side wall that is located on a side opposite to the second direction and covers the housing and the retainer, and a part of the first side wall covering the retainer is provided with a through hole penetrating the first side wall.

With the connector and the connector assembly according to the present disclosure, the retainer can be easily final-locked to the housing within the hood member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to an embodiment.

FIG. 2 is an exploded perspective view of the connector according to the embodiment.

FIG. 3 is a cross-sectional view taken along line 3-3 in FIG. 1.

FIG. 4 is a schematic explanatory view of a forming die for forming a hood member.

FIG. 5 is a cross-sectional view taken along line 5-5 in FIG. 3.

FIG. 6 is an exploded cross-sectional view of a connector assembly before fitting according to the embodiment.

FIG. 7 is a perspective view for explaining a method of assembling the connector according to the embodiment.

FIG. 8 is a cross-sectional view for explaining the method of assembling the connector according to the embodiment.

FIG. 9 is a cross-sectional view taken along line 9-9 in FIG. 8.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

[1] A connector comprising: a housing that accommodates terminals; a retainer that is assembled to the housing to hold the terminals in the housing; and a hood member that has an opening and accommodates the housing and the retainer, wherein the housing and the retainer are assembled into the hood member from the opening in a first direction, the retainer is assembled to the housing in a second direction intersecting the first direction, the retainer is movable in the second direction relative to the housing from a provisional locking position that allows movement of the terminals to a final locking position that restricts the movement of the terminals, within the hood member, the hood member includes a first side wall that is located on a side opposite to the second direction and covers the housing and the retainer, and a part of the first side wall covering the retainer is provided with a through hole penetrating the first side wall.

With this configuration, the retainer can be pushed linearly in the second direction from outside the hood member by using a jig that is insertable through the through hole provided in the hood member. In this case, it is not necessary to finely manipulate the jig, so that the retainer can be easily moved from the provisional locking position to the final locking position within the hood member. Therefore, the retainer can be easily final-locked to the housing within the hood member.

[2] In the above [1], the through hole included in the hood member may comprise a plurality of through holes arranged in a third direction intersecting both the first direction and the second direction. With this configuration, a plurality of parts of the retainer can be simultaneously pushed by using a jig having a plurality of parts that are simultaneously insertable into the plurality of through holes. Hence, the retainer can be pushed evenly from the provisional locking position to the final locking position. As a result, the retainer can be prevented from misalignment, for example, tilting.

[3] In the above [1] or [2], an inner groove extending in the first direction from an edge on a side where the opening is located to the through hole may be provided on an inner surface of the first side wall, and an outer groove extending in the first direction from the through hole to an edge on a side opposite to the opening may be provided on an outer surface of the first side wall.

[4] In the above [3], a position of a bottom surface of the inner groove in the second direction may be same as a position of a bottom surface of the outer groove in the second direction. With this configuration, the hood member having the through hole can be formed using a forming die with a simple structure in which the direction of relative movement is one direction.

[5] A connector assembly comprising: the connector according to the above [3] or [4]; and a mating connector inserted into the hood member of the connector, wherein the mating connector includes a protrusion extending in the first direction and inserted into the inner groove. With this configuration, play of the connector portion relative to the connector can be suppressed by insertion of the protrusion into the inner groove of the connector.

### Details of Embodiments of the Present Disclosure

Specific examples of a connector according to the present disclosure will be described below with reference to the drawings. In the drawings, some components may be exaggerated or simplified for convenience of explanation. Dimensional ratios of respective parts may differ among the drawings. The terms “orthogonal” and “parallel” in this specification do not only refer to strictly orthogonal or parallel, but also include substantially orthogonal or parallel within the range in which the effects of this embodiment are achieved. Furthermore, terms such as “first,” “second,” and “third” in this specification are used simply to distinguish between objects, and are not used to rank the objects.

In the drawings, mutually orthogonal X-axis, Y-axis, and Z-axis are shown. Hereinafter, as an example, a case will be described in which a connector 10 is arranged such that the Z-axis direction is the upward direction. The connector 10 is not limited to use in this orientation, and may be used in orientations in which the Z-axis direction is other than the upward direction, for example, the downward direction or horizontal direction. Each axial direction such as the Z-axis direction means the direction toward which the tip of the arrow of the axis points. In the example of the connector 10 described below, a first direction D1 is the Y-axis direction, a second direction D2 is a direction opposite to the Z-axis direction, and a third direction D3 is the X-axis direction.

### Connector 10

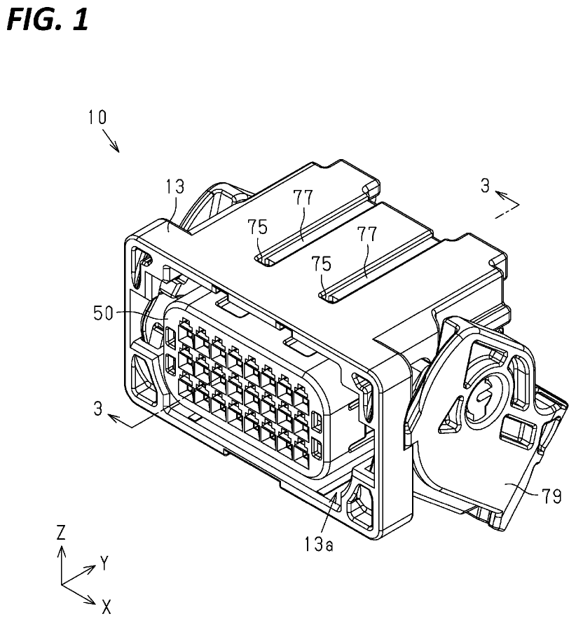

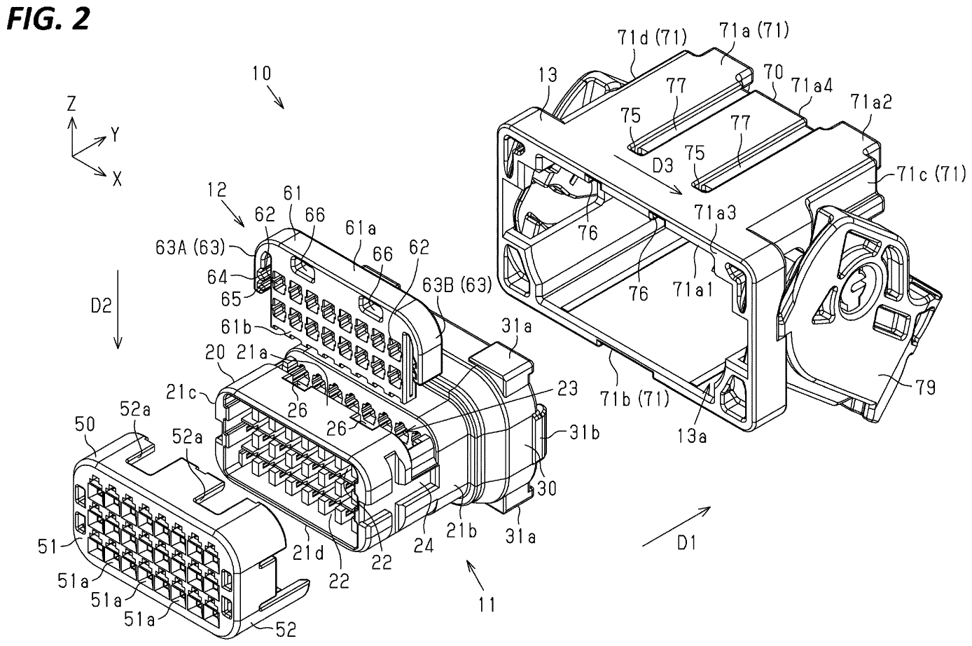

As shown in FIGS. 1 and 2, the connector 10 includes a housing 11 that accommodates terminals (not shown), a retainer 12 for holding the terminals in the housing 11, and a hood member 13 that accommodates the housing 11 and the retainer 12. Electric wires (not shown) are connected to the terminals. The electric wires are drawn out from the below-described end wall 70 of the hood member 13 in the first direction D1.

### Configuration of Housing 11

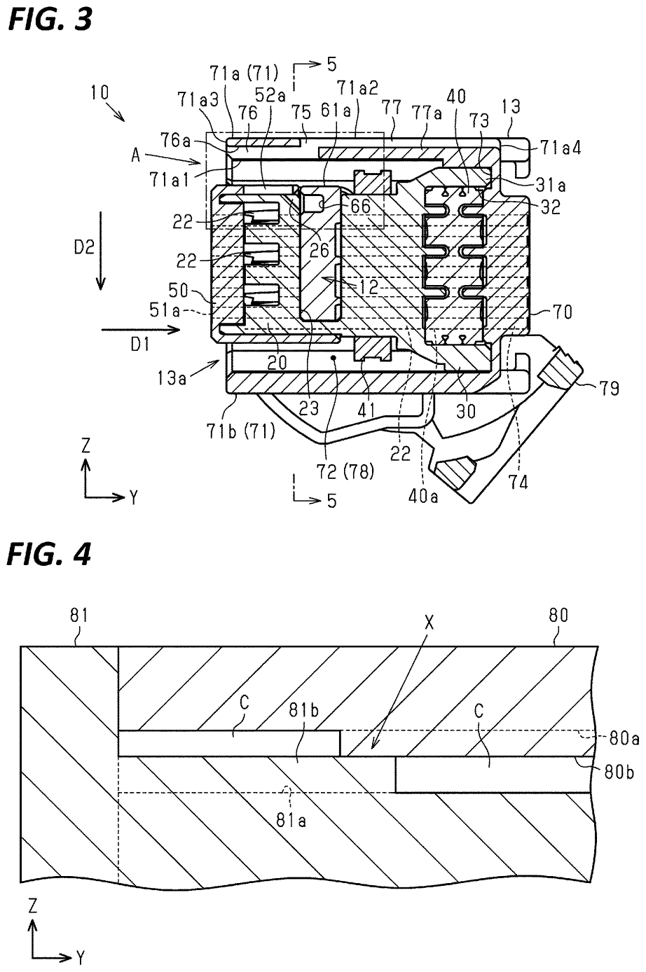

As shown in FIGS. 2 and 3, the housing 11 includes a terminal accommodating portion 20 located on the proximal side (base end side) in the first direction D1 (i.e., the side opposite to the first direction D1), and a mounting portion 30 located on the distal side in the first direction D1 (i.e. the first direction D1 side) and formed integrally with the terminal accommodating portion 20.

The terminal accommodating portion 20 has a first outer surface 21a that faces in the Z-axis direction, a second outer surface 21b that faces in the X-axis direction, a third outer surface 21c that faces in the direction opposite to the X-axis direction, and a fourth outer surface 21d that faces in the direction opposite to the Z-axis direction.

A plurality of terminal accommodating chambers 22 are formed inside the terminal accommodating portion 20. Each of the terminal accommodating chambers 22 is a through hole that extends in the first direction D1 and opens at the proximal side and the distal side in the first direction D1. In the terminal accommodating portion 20, the plurality of terminal accommodating chambers 22 are arranged in each of the X-axis direction and the Z-axis direction. Terminals (not shown) are accommodated in the terminal accommodating portion 20. Electric wires (not shown) connected to the terminals are drawn out from the openings of the terminal accommodating chambers 22 on the distal side in the first direction D1 into the mounting portion 30.

A retainer attachment portion 23 is formed at an intermediate part in the first direction D1 of the terminal accommodating portion 20. The retainer attachment portion 23 is a slit-shaped recess that opens on the first outer surface 21a. The retainer attachment portion 23 has a shape extending in the Y-axis direction and the Z-axis direction. The retainer attachment portion 23 is formed so as to intersect all of the terminal accommodating chambers 22. In other words, each of the terminal accommodating chambers 22 is formed across the retainer attachment portion 23 on both sides of the retainer attachment portion 23, that is, on the side opposite to the first direction D1 and on the first direction D1 side.

As shown in FIG. 2, a locked portion 24 for locking the below-described final locking portion 64 of the retainer 12 is provided on each of the second outer surface 21b and the third outer surface 21c of the terminal accommodating portion 20. In one example, the locked portion 24 is a recess with which the final locking portion 64 is locked by projection-recess engagement. The locked portion 24 on the second outer surface 21b is located on the X-axis direction side of the terminal accommodating portion 20. The locked portion 24 on the third outer surface 21c is located on the side opposite to the X-axis direction side of the terminal accommodating portion 20.

The corner formed by the wall surface of the retainer attachment portion 23 located on the proximal side in the first direction D1 and the first outer surface 21a is partially cut away to form cutout portions 26. In this embodiment, two cutout portions 26 are spaced apart in the X-axis direction.

Housing-side fitting portions 31a that engage with the hood member 13 are provided on the outer surface of the mounting portion 30. In one example, the housing-side fitting portions 31a are projections that protrude from the outer surface of the mounting portion 30 in the Z-axis direction and in the direction opposite to the Z-axis direction. In addition, claw-shaped housing-side locking portions 31b protrude from the outer surface of the mounting portion 30 in the X-axis direction and in the direction opposite to the X-axis direction.

As shown in FIG. 3, a seal attachment portion 32 is provided inside the mounting portion 30. The seal attachment portion 32 is a recess that opens in the first direction D1. The terminal accommodating chambers 22 in the terminal accommodating portion 20 open into the seal attachment portion 32. In other words, the terminal accommodating chambers 22 communicate with the seal attachment portion 32.

A first seal member 40 formed of an elastic material such as rubber is attached inside the seal attachment portion 32. The first seal member 40 is provided with a plurality of seal holes 40a through which electric wires (not shown) drawn out from the terminal accommodating portion 20 are inserted. In the first seal member 40, the plurality of seal holes 40a are located facing the respective plurality of terminal accommodating chambers 22 in the terminal accommodating portion 20. In the seal holes, the first seal member 40 is brought into close contact with the outer peripheral surfaces of the electric wires, thereby providing waterproofing.

As shown in FIG. 2, a cover 50 is attached to the proximal end part in the first direction D1of the housing 11. The cover 50 includes a cover end wall 51 that partially closes the opening of the terminal accommodating portion 20 on the proximal side in the first direction D1. The cover end wall 51 is provided with insertion holes 51a through which mating terminals are inserted, at positions facing the plurality of terminal accommodating chambers 22. Each insertion hole 51a penetrates the cover end wall 51 in the first direction D1. The cover 50 includes a cover peripheral wall 52 that covers the first outer surface 21a, the second outer surface 21b, the third outer surface 21c, and the fourth outer surface 21d of the terminal accommodating portion 20. The part of the cover peripheral wall 52 covering the first outer surface 21a of the terminal accommodating portion 20 is provided with exposure portions 52a for exposing the cutout portions 26. In one example, the exposure portions 52a are cutouts formed by cutting away the cover peripheral wall 52 from the edge on the distal side in the first direction D1.

As shown in FIG. 3, a second seal member 41 is attached to the outer peripheral surface of the part of the terminal accommodating portion 20 on the first direction D1 side relative to the retainer attachment portion 23, that is, the part located between the retainer attachment portion 23 and the mounting portion 30. The second seal member 41 is an annular member formed of an elastic material such as rubber. In FIG. 2, illustration of the second seal member 41 is omitted in order to show the outer peripheral shape of the housing 11.

### Configuration of Retainer 12

As shown in FIG. 2, the retainer 12 includes a retainer body 61 that is inserted into the retainer attachment portion 23 in the terminal accommodating portion 20. The retainer body 61 is a plate-shaped portion extending in the X-axis direction and the Z-axis direction. The retainer body 61 is provided with a plurality of retainer through holes 62 extending in the first direction D1. In the terminal accommodating portion 20, the retainer through holes 62 are located between the terminal accommodating chambers 22 that are arranged in the first direction D1 with the retainer attachment portion 23 interposed therebetween, causing the terminal accommodating chambers 22 to communicate with each other in the first direction D1.

The retainer 12 includes a retainer mounting portion 63 for mounting the retainer 12 to the housing 11. The retainer mounting portion 63 includes a first arm 63A extending in the X-axis direction from the distal end in the Y-axis direction of the retainer body 61, and a second arm 63B extending in the direction opposite to the X-axis direction from the distal end in the Y-axis direction of the retainer body 61. The first arm 63A and the second arm 63B are disposed outside the housing 11. As a result of the first arm 63A and the second arm 63B sandwiching the housing 11 in the X-axis direction, the retainer 12 is locked to the housing 11.

The first arm 63A and the second arm 63B are provided with final locking portions 64 that are locked to the locked portions 24 of the housing 11. In one example, each final locking portion 64 is a claw portion protruding toward the housing 11. The first arm 63A and the second arm 63B are also provided with, on the distal side relative to the final locking portions 64, provisional locking portions 65 that are locked to the locked portions 24 of the housing 11 when the retainer 12 is at a provisional locking position (described later). In one example, each provisional locking portion 65 is a claw portion protruding toward the housing 11.

The retainer body 61 has a retainer end surface 61a that faces in the Z-axis direction, and an opening-side surface 61b that faces in the direction opposite to the Y-axis direction. The opening-side surface 61b can also be regarded as facing the proximal side in the first direction D1. The retainer end surface 61a is a plane orthogonal to the second direction D2 (Z-axis direction). The opening-side surface 61b is provided with two release-jig holes 66 that face the cutout portions 26.

The retainer 12 is lockable to the housing 11 at both a provisional locking position and a final locking position.

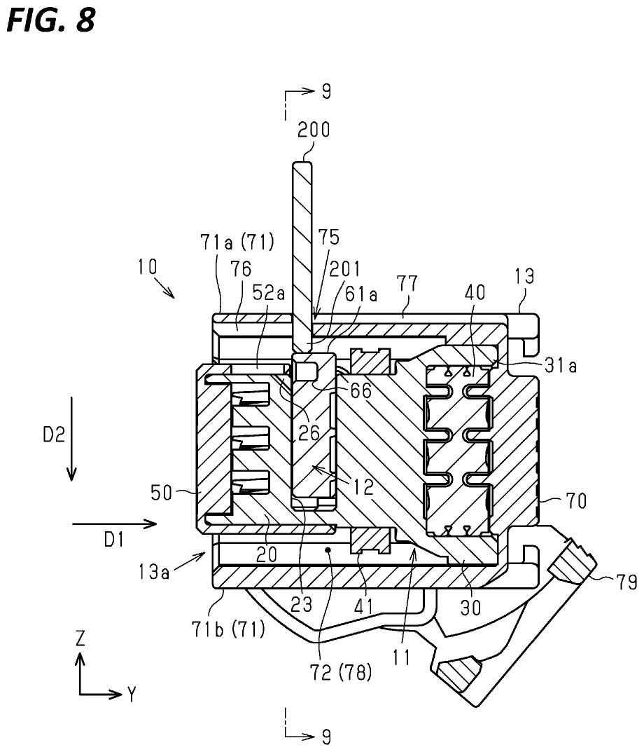

As shown in FIG. 3, the final locking position is the position of the retainer 12 in the assembled connector 10. As shown in FIG. 8, the provisional locking position is set as a position during insertion of the retainer 12 into the retainer attachment portion 23. Therefore, the final locking position can also be regarded as a position as a result of further inserting the retainer 12 in the first direction D1 from the provisional locking position. When the retainer 12 is at the provisional locking position, the retainer end surface 61a of the retainer 12 is positioned higher on the Z-axis than when the retainer 12 is at the final locking position. The provisional locking position is set such that the retainer end surface 61a does not interfere with the hood member 13. Thus, the retainer 12 is movable in the second direction D2 from the provisional locking position to the final locking position within the hood member 13.

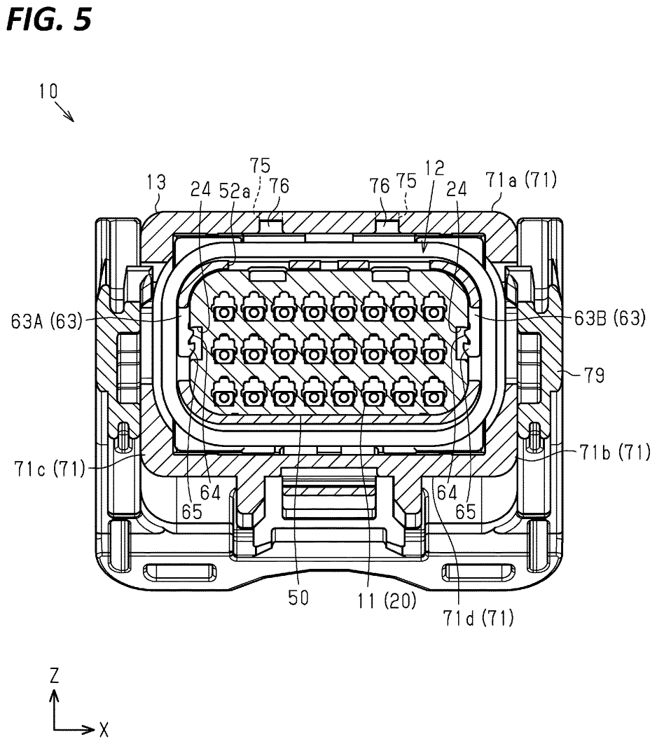

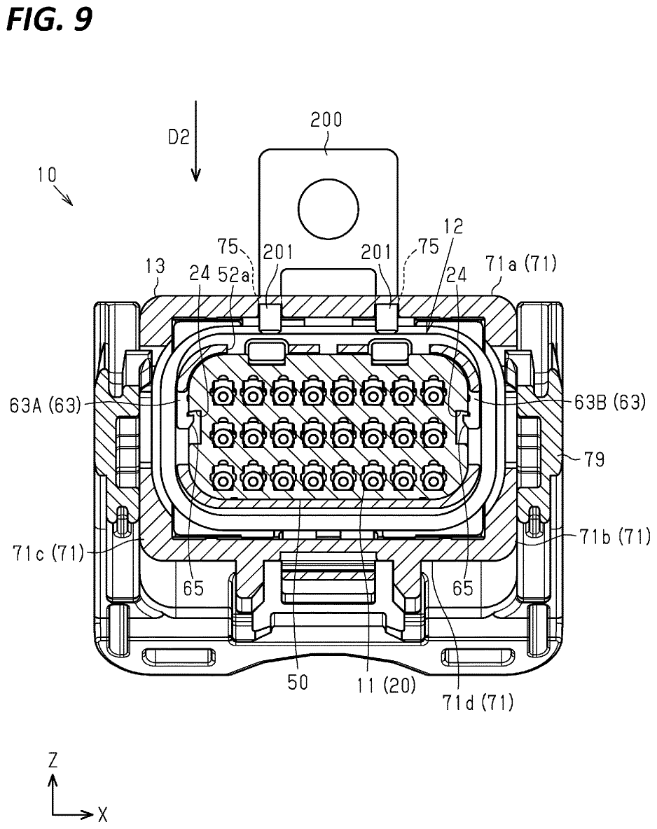

As shown in FIG. 5, when the retainer 12 is at the final locking position, the final locking portions 64 provided on the first arm 63A and the second arm 63B of the retainer 12 are locked to the locked portions 24 of the housing 11. Thus, the retainer 12 is locked to the housing 11 at the final locking position. As shown in FIG. 9, when the retainer 12 is at the provisional locking position, the provisional locking portions 65 provided on the first arm 63A and the second arm 63B of the retainer 12 are locked to the locked portions 24 of the housing 11. Thus, the retainer 12 is locked to the housing 11 at the provisional locking position.

When the retainer 12 is at the final locking position, the retainer 12 is positioned to lock the terminals accommodated in the terminal accommodating chambers 22 so as to prevent the terminals from coming out, thereby restricting rearward movement of the terminals within the terminal accommodating chambers 22. As a result, the terminals are held in the terminal accommodating chambers 22. When the retainer 12 is at the provisional locking position, the retainer 12 is positioned not to interfere with the terminals accommodated in the terminal accommodating chambers 22, thereby allowing movement of the terminals within the terminal accommodating chambers 22.

### Configuration of Hood Member 13

As shown in FIGS. 2 and 3, the hood member 13 has an opening 13a. In one example, the hood member 13 has a bottomed box shape with an opening on the proximal side in the first direction D1. The hood member 13 includes a rectangular end wall 70 and side walls 71 extending from the respective sides of the rectangular end wall 70 in the direction opposite to the first direction D1 in a rectangular tubular shape. The side walls 71 include a first side wall 71a and a second side wall 71b spaced apart in the Z-axis direction, and a third side wall 71c and a fourth side wall 71d spaced apart in the X-axis direction.

As shown in FIG. 3, an accommodating chamber 72 for accommodating the housing 11 and the retainer 12 is formed inside the hood member 13. Within the accommodating chamber 72, fitting portions 73 for fixing the housing 11 are provided at the distal ends in the first direction D1 of the side walls 71 and at the end wall 70. The fitting portions 73 are recesses into which the housing-side fitting portions 31a of the housing 11 are fitted.

The end wall 70 of the hood member 13 is provided with insertion holes 74 through which electric wires are inserted. The electric wires are drawn out from inside the hood member 13 in the first direction D1 through the insertion holes 74 of the end wall 70.

The first side wall 71a of the hood member 13 has an inner surface 71a1 that faces the accommodating chamber 72 and an outer surface 71a2 opposite to the inner surface 71a1. The center part in the first direction D1 of the first side wall 71a is provided with through holes 75 penetrating the first side wall 71a and opening on both the inner surface 71a1 and the outer surface 71a2. The through holes 75 are provided at a position overlapping the retainer end surface 61a of the retainer 12 in the second direction D2 (Z-axis direction). Accordingly, the through holes 75 partially expose the retainer end surface 61a of the retainer 12. The through holes 75 are smaller in area than the retainer end surface 61a of the retainer 12 when viewed in the second direction D2.

The cross-sectional shape of each through hole 75 is not particularly limited. Examples of the cross-sectional shape of the through hole 75 include polygonal and circular. In the illustrated example, the cross-sectional shape of the through hole 75 is rectangular. The first side wall 71a has two through holes 75 arranged in the X-axis direction. In this case, the X-axis direction in which the through holes 75 are arranged is the third direction D3 intersecting both the first direction D1 and the second direction D2.

Inner grooves 76 each extending linearly in the first direction D1 from a first edge 71a3, which is the edge located on the opening 13a side, to the through hole 75 are provided on the inner surface 71a1 of the first side wall 71a. Further, outer grooves 77 each extending linearly in the first direction D1 from the through hole 75 to a second edge 71a4, which is the edge located on the side opposite to the opening 13a, are provided on the outer surface 71a2 of the first side wall 71a. Accordingly, the inner groove 76 and the outer groove 77 arranged in the first direction D1 are connected to each other through the through hole 75.

The cross-sectional shape of each of the inner groove 76 and the outer groove 77 orthogonal to the first direction D1 is constant in the first direction D1. The inner groove 76 has an inner bottom surface 76a serving as a bottom surface. The outer groove 77 has an outer bottom surface 77a serving as a bottom surface.

The inner bottom surface 76a of the inner groove 76 and the outer bottom surface 77a of the outer groove 77 overlap each other in the first direction D1. In one example, the inner bottom surface 76a and the outer bottom surface 77a are positioned on the same plane extending in the first direction D1. In this case, both the inner bottom surface 76a and the outer bottom surface 77a are planar. In another example, the inner bottom surface 76a and the outer bottom surface 77a are positioned on the same curved surface extending in the first direction D1. In this case, one of the inner bottom surface 76a and the outer bottom surface 77a has a convex curved shape along the curved surface, and the other of the inner bottom surface 76a and the outer bottom surface 77a has a concave curved shape along the curved surface.

In the illustrated example, both the inner groove 76 and the outer groove 77 are rectangular. The position of the inner bottom surface 76a in the second direction D2 (Y-axis direction) is the same as the position of the outer bottom surface 77a in the second direction D2 (Y-axis direction). By forming the inner groove 76 and the outer groove 77 as described above, the hood member 13 having the through hole 75 in the first side wall 71a can be formed without using a die having a complicated structure.

In detail, as shown in FIG. 4, a first die 80 and a second die 81 that are relatively movable in the Y-axis direction and the direction opposite to the Y-axis direction are used as a forming die. FIG. 4 shows the parts of the first die 80 and the second die 81 for forming the part of the hood member 13 indicated by range A in FIG. 3. The first die 80 and the second die 81 form a cavity C for forming the hood member 13 therein by moving the first die 80 in the direction opposite to the Y-axis direction relative to the second die 81. For example, the first die 80 is a movable die mainly for forming the outer surface side of the hood member 13, and the second die 81 is a fixed die mainly for forming the inner surface side of the hood member 13.

An inner protrusion 81b for forming the inner groove 76 is provided on a wall surface 81a of the second die 81 for forming the inner surface 71a1 of the first side wall 71a of the hood member 13. Similarly, an outer protrusion 80b for forming the outer groove 77 is provided on a wall surface 80a of the first die 80 for forming the outer surface 71a2 of the first side wall 71a of the hood member 13. Here, the inner protrusion 81b and the outer protrusion 80b are formed such that their tip end parts contact each other in the Z-axis direction. In this case, the through hole 75 is formed at a part X where the tip end part of the inner protrusion 81b and the tip end part of the outer protrusion 80b contact each other. Thus, the hood member 13 having the through hole 75 can be formed by using a forming die with a simple structure in which the direction of relative movement is one direction.

As shown in FIG. 2, one pair of the inner groove 76 and the outer groove 77 are provided for each through hole 75. Since there are two through holes 75 in the illustrated example, two pairs of the inner groove 76 and the outer groove 77 are provided.

Levers 79 for fixing the connector 10 to a mating connector 100 (described later) are attached to the outer surfaces of the third side wall 71c and the fourth side wall 71d. One example of the connector 10 is a lever-equipped connector.

As shown in FIG. 3, in the accommodating chamber 72 of the hood member 13, an insertion recess 78 for inserting the mating connector 100 is formed between the hood member 13 and the terminal accommodating portion 20 of the housing 11. The insertion recess 78 is an annular recess that opens to the opening 13a side of the hood member 13.

### Connector Assembly

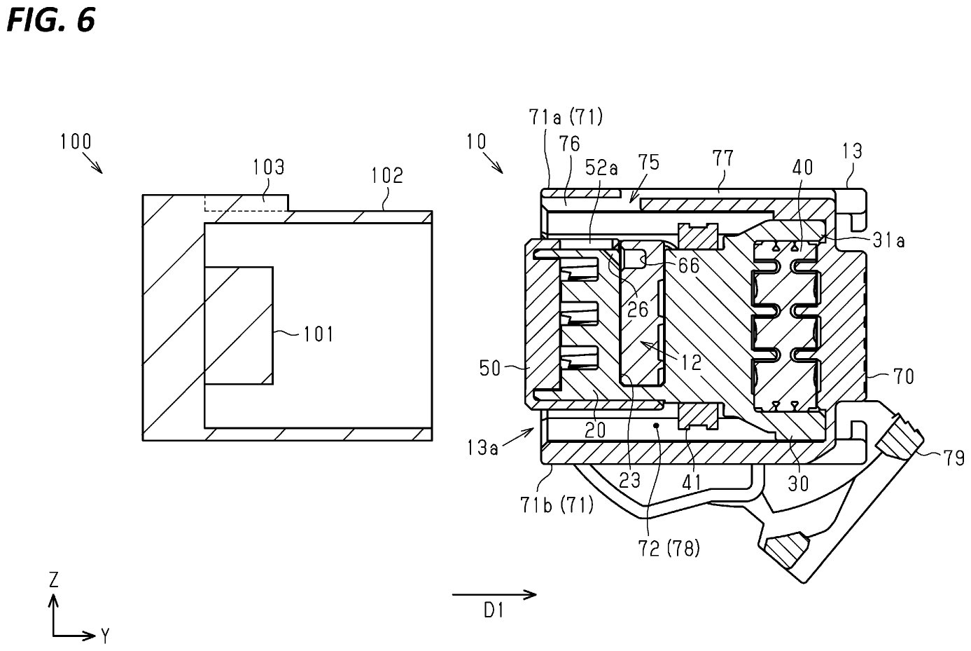

As shown in FIG. 6, a connector assembly includes the connector 10 and the mating connector 100. The mating connector 100 includes a connector portion 101 that accommodates mating terminals (not shown), and a mating housing 102 that accommodates the connector portion 101. The mating housing 102 opens in the first direction D1. Electric wires (not shown) are connected to the mating terminals in the connector portion 101. The electric wires are drawn out from the connector portion 101 in the direction opposite to the first direction D1.

The connector portion 101 and the mating housing 102 are inserted into the insertion recess 78 of the hood member 13 of the connector 10 from the opening 13a in the first direction D1. In a state in which the mating connector 100 is fitted into the connector 10, the terminals accommodated in the housing 11 are electrically connected to the mating terminals included in the mating connector 100. At this time, the second seal member 41 of the connector 10 is brought into close contact with the inner surface of the mating housing 102 of the mating connector 100 inserted into the hood member 13.

Protrusions 103 extending in the first direction D1 are formed on the outer surface of the mating housing 102. The protrusions 103 are inserted into the inner grooves 76 of the hood member 13 of the connector 10. By being inserted into the inner grooves 76 of the connector 10, the protrusions 103 function as a play-reducing portion that suppresses play of the connector portion 101 in the X-axis direction relative to the connector 10.

### Functions of This Embodiment

The functions of this embodiment will be described below.

The connector 10 can be assembled as follows.

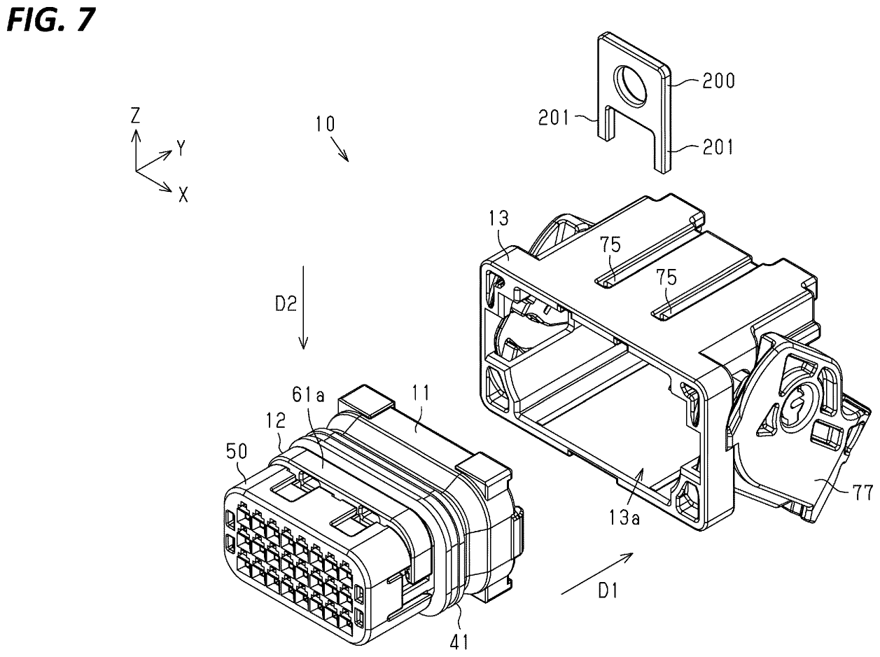

As shown in FIG. 7, first, the cover 50, the retainer 12, the first seal member 40, and the second seal member 41 are assembled to the housing 11.

The cover 50 is assembled to the proximal end in the first direction D1 of the terminal accommodating portion 20 of the housing 11, in the first direction D1. The retainer 12 is assembled to the housing 11 in the second direction D2, thereby being inserted into the retainer attachment portion 23 of the housing 11. Here, the retainer 12 is assembled so as to be located at the provisional locking position with respect to the housing 11. The first seal member 40 is assembled to the mounting portion 30 in the direction opposite to the first direction D1. Hereinafter, the housing 11 to which the cover 50, the retainer 12, the first seal member 40, and the second seal member 41 are assembled is also referred to as a housing assembly.

Next, the housing assembly is assembled to the hood member 13. The housing assembly is assembled into the accommodating chamber 72 of the hood member 13 from the opening 13a in the first direction D1. Here, the housing-side fitting portion 31a of the housing 11 and the fitting portion 73 provided in the accommodating chamber 72 of the hood member 13 are fitted together. Moreover, the housing-side locking portion 31b of the housing 11 is locked to a locking portion (not shown) provided in the accommodating chamber 72 of the hood member 13. As a result, the housing assembly is fixed to the hood member 13. After this, the terminals are inserted into the terminal accommodating portion 20 through the insertion holes 74 provided in the end wall 70 of the hood member 13 and the seal holes 40a of the first seal member 40.

Next, as shown in FIGS. 8 and 9, a jig 200 is used to push the retainer 12 in the second direction D2 from outside the hood member 13, thereby moving the retainer 12 from the provisional locking position to the final locking position. As shown in FIG. 7, the jig 200 includes two columnar pushing portions 201. The pushing portions 201 are shaped to be insertable into the through holes 75 of the hood member 13. The spacing between the two columnar pushing portions 201 is equal to the spacing between the two through holes 75 of the hood member 13.

As shown in FIGS. 8 and 9, the two pushing portions 201 of the jig 200 are inserted into the two through holes 75 from outside the hood member 13, and their tips are brought into contact with the retainer end surface 61a of the retainer 12. The jig 200 is then pushed in the second direction D2. This causes the retainer 12 to move from the provisional locking position to the final locking position and be locked at the final locking position. As a result of the retainer 12 being locked at the final locking position, movement of the terminals accommodated in the terminal accommodating chambers 22 is restricted.

The connector 10 can be assembled as a result of the above operations.

In the case of disassembling the connector 10, for example, columnar jigs are inserted from the opening 13a into the insertion recess 78 inside the hood member 13. The tips of the columnar jigs are then inserted into the release-jig holes 66 of the retainer 12 through the exposure portions 52a of the cover 50 and the cutout portions 26 of the retainer 12. Then, by operating the columnar jigs so as to lift the retainer 12, the retainer 12 is moved from the final locking position to the provisional locking position. This allows movement of the terminals accommodated in the terminal accommodating chambers 22, with it being possible to remove the terminals. Thereafter, the connector 10 can be disassembled by performing operations that is the reverse of the assembly.

### Effects of This Embodiment

The effects of this embodiment will be described.

(1) A connector 10 comprises: a housing 11 that accommodates terminals; a retainer 12 that is assembled to the housing 11 to hold the terminals in the housing 11; and a hood member 13 that has an opening 13a and accommodates the housing 11 and the retainer 12. The housing 11 and the retainer 12 are assembled into the hood member 13 from the opening 13a in a first direction D1. The retainer 12 is assembled to the housing 11 in a second direction D2 intersecting the first direction D1. The retainer 12 is movable in the second direction D2 relative to the housing 11 from a provisional locking position that allows movement of the terminals to a final locking position that restricts the movement of the terminals, within the hood member 13. The hood member 13 includes a first side wall 71a that is located on a side opposite to the second direction D2 and covers the housing 11 and the retainer 12. A part of the first side wall 71a covering the retainer 12 is provided with a through hole 75 penetrating the first side wall 71a.

With this configuration, the retainer 12 can be pushed linearly in the second direction D2 from outside the hood member 13 by using a jig 200 including a pushing portion 201 that is insertable through the through hole 75 provided in the hood member 13. In this case, it is not necessary to finely manipulate the jig 200, so that the retainer 12 can be easily moved from the provisional locking position to the final locking position within the hood member 13. Therefore, the retainer 12 can be easily final-locked to the housing 11 within the hood member 13.

(2) The through hole 75 included in the hood member 13 comprises a plurality of through holes 75 arranged in a third direction D3 intersecting both the first direction D1 and the second direction D2. With this configuration, a plurality of parts of the retainer end surface 61a of the retainer 12 can be simultaneously pushed by using the jig 200 having the plurality of pushing portions 201 that are simultaneously insertable into the plurality of through holes 75. Hence, the retainer 12 can be pushed evenly from the provisional locking position to the final locking position without misalignment, for example, tilting.

(3) An inner groove 76 extending in the first direction D1 from a first edge 71a3 on a side where the opening 13a is located to the through hole 75 is provided on an inner surface 71a1 of the first side wall 71a. An outer groove 77 extending in the first direction D1 from the through hole 75 to a second edge 71a4 on a side opposite to the opening 13a is provided on an outer surface 71a2 of the first side wall 71a. A position of an inner bottom surface 76a which is the bottom surface of the inner groove 76 in the second direction D2 is same as a position of an outer bottom surface 77a which is the bottom surface of the outer groove 77 in the second direction D2. With this configuration, the hood member 13 having the through hole 75 can be formed using a forming die with a simple structure in which the direction of relative movement is one direction, as shown in FIG. 4.

(4) A connector assembly comprises: the connector 10; and a mating connector 100 inserted into the hood member 13 of the connector 10. The mating connector 100 includes a protrusion 103 extending in the first direction D1 and inserted into the inner groove 76. With this configuration, play of the connector portion 101 relative to the connector 10 in the X-axis direction can be suppressed by insertion of the protrusion 103 into the inner groove 76 of the connector 10.

### Other Embodiments

The above embodiment can be modified and implemented as below. The above embodiment and the modifications described below may be combined unless they are technically inconsistent.
The second direction D2 is any direction intersecting the first direction D1, and is not limited to being orthogonal to the first direction D1. For example, in the above embodiment, the second direction D2 may be inclined with respect to the Z-X plane.
The third direction D3 is any direction intersecting both the first direction D1 and the second direction D2, and is not limited to being orthogonal to both the first direction D1 and the second direction D2. For example, in the above embodiment, the third direction D3 may be inclined with respect to the Y-Z plane.
The number of through holes 75 formed in the hood member 13 is not particularly limited, and may be one or three or more.
The arrangement of through holes 75 in the hood member 13 is not particularly limited. For example, in the case where a plurality of through holes 75 are provided, some of the through holes 75 may be arranged in the first direction D1. When forming the hood member 13 using a forming die in which the direction of relative movement is one direction, it is preferable not to arrange the plurality of through holes 75 in the first direction D1.
Either one or both of the inner groove 76 and the outer groove 77 may be omitted from the hood member 13.
The lever 79 may be omitted from the hood member 13.
The protrusion 103 may be omitted from the mating connector 100.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing that accommodates terminals;
a retainer that is assembled to the housing to hold the terminals in the housing; and
a hood member that has an opening and accommodates the housing and the retainer,
wherein the housing and the retainer are assembled into the hood member from the opening in a first direction,
the retainer is assembled to the housing in a second direction intersecting the first direction,
the retainer is movable in the second direction relative to the housing from a provisional locking position that allows movement of the terminals to a final locking position that restricts the movement of the terminals, within the hood member,
the hood member includes a first side wall that is located on a side opposite to the second direction and covers the housing and the retainer, and
a part of the first side wall covering the retainer is provided with a through hole penetrating the first side wall.

2. The connector according to claim 1, wherein the through hole included in the hood member comprises a plurality of through holes arranged in a third direction intersecting both the first direction and the second direction.

3. The connector according to claim 1, wherein an inner groove extending in the first direction from an edge on a side where the opening is located to the through hole is provided on an inner surface of the first side wall, and
an outer groove extending in the first direction from the through hole to an edge on a side opposite to the opening is provided on an outer surface of the first side wall.

4. The connector according to claim 3, wherein a position of a bottom surface of the inner groove in the second direction is same as a position of a bottom surface of the outer groove in the second direction.

5. A connector assembly comprising:
the connector according to claim 3; and
a mating connector inserted into the hood member of the connector,
wherein the mating connector includes a protrusion extending in the first direction and inserted into the inner groove.
